(19) United States
(12) Patent Application Publication
(10) Pub. No.: US 2004/0140293 A1
(43) Pub. Date: Jul. 22, 2004

(54) Method and device for connecting minute joint metal, and composite tape for connecting minute joint metal

(76) Inventors: Kyouichi Kohama, Toride-shi Ibaraki (JP); Yoshinari Satou, Higashiiwai-gun Iwate (JP)

Correspondence Address: MCDERMOTT WILL & EMERY, 600 13TH STREET, N.W., WASHINGTON, DC, 20005-3096, US

(21) Appl. No.: 10/433,277

(22) PCT Filed: Dec. 3, 2001
(86) PCT No.: PCT/JP01/10536

(30) Foreign Application Priority Data
Dec. 4, 2000 (JP) 2000-368776

(51) Int. Cl. B23K 1/00

(52) U.S. Cl. 219/85.22; 219/85.18; 219/85.19

(57) ABSTRACT

An object of the invention is to join a minute joint metal to a base metal in such a manner that the minute joint metal does not break in the joining, that the strength is not weakened in the base metal and the minute joint metal, and that the strength of the joining is increased. The invention comprises the steps of: contacting a minute joint metal, a base metal, and a brazing filler material to each other; pressing an electrically conductive tape toward these materials by means of a heating head; heating the electrically conductive tape; fusing the brazing filler material by means of the heat conducted from the electrically conductive tape which is heated; and joining the minute joint metal to the base metal with said fused brazing filler material.

### TECHNICAL FIELD

The present invention relates to a joining method for minute joint metal, a joining device for minute joint metal, and a combined joining tape for minute joint metal used for joining a minute joint metal such as a thin wire to a base metal such as a terminal of an electronic component.

### BACKGROUND ART

When a minute joint metal such as an end of a thin wire is to be joined to a base metal such as a terminal, methods used for this purpose include: so-called non-contact type joining methods such as micro laser beam welding and micro arc welding; and so-called contact type joining methods such as micro spot welding and pulse heat joining.

Micro spot welding (fusing welding) which is a contact type joining method is described below as an example. As shown in FIG. 25, a terminal 3 having been bent in a U-shape is inserted between up and down electrodes 1a and 1b, while an end portion 5 of an insulated wire 4 is clamped inside the terminal 3. Then, electric power is supplied in a state that a pressuring force is applied on the electrodes 1a and 1b, whereby coating material 6 is burnt off by the Joule heat generated in the terminal 3, so that electric conduction is obtained between the terminal 3 and the wire 4 (see “The Handbook of Modern Joining Technology” (Industrial Technology Service Center Co., Ltd., Apr. 15, 1984) etc.).

In such a prior art joining method for minute joint metal, since electric power is supplied in a state that the terminal is pressured, damage occurs to the terminal, and thereby reduces the strength of the terminal as well as the strength of the joining. Further, there has been a problem that the wire easily breaks and that, for example, a thin wire of 0.1 mm or smaller in diameter easily melts and breaks in the process of energizing and pressuring.

On the other hand, micro laser beam welding and micro arc welding which are non-contact type joining methods need an additional mechanism for pressing together the materials to be welded. Further, for example, in the joining of a thin wire of 0.1 mm or smaller in diameter, there has been a problem that it is difficult to control the amount of energy of the laser beam or the arc to avoid the melt and break of the thin wire caused by the laser beam or the arc.

### DISCLOSURE OF INVENTION

The invention has been devised with considering the above-mentioned problems. An object of the invention is to provide a method for joining a minute joint metal to a base metal in such a manner that the minute joint metal does not break in the joining, that the strength is not weakened in the base metal and the minute joint metal, and that the strength of the joining is increased. The method comprises the steps of: contacting a minute joint metal, abase metal, and a brazing filler material to each other; pressing an electrically conductive tape toward these materials by means of a heating head; heating the electrically conductive tape; fusing the brazing filler material by means of the heat conducted from the electrically conductive tape which is heated; and joining the minute joint metal to the base metal with said fused brazing filler material.

Further, a joining device used in the invention comprises: a tape feed unit; a heating head (unit) for heating an electrically conductive tape; a press unit for pressing said heating head toward the base metal; a traverse unit for causing the entirety of said units to travel as a single unit; and a base metal support bed.

### BRIEF DESCRIPTION OF DRAWINGS

FIG. 1 shows an example of Embodiment 1 of the invention for contacting a minute joint metal, abase metal, and a brazing filler material to each other.

FIG. 2 shows an example of Embodiment 2 of the invention for contacting a minute joint metal, abase metal, and a brazing filler material to each other.

FIG. 3 shows an example of Embodiment 3 of the invention for contacting a minute joint metal, a base metal, and a brazing filler material to each other.

FIG. 4 is a perspective view showing an example of an electronic component to which the invention is applied.

FIG. 5 is a perspective view showing an example (type A) of a joining device used in the invention.

FIG. 6 is a front view showing an example (type A) of a joining device used in the invention.

FIG. 7 is a side view showing an example (type A) of a joining device used in the invention.

FIG. 8 shows the main part of a heating head of a type-A joining device, together with the relation to a heating tape and a brazing filler material tape.

FIG. 9 shows the tape of FIG. 8 viewed from a Z-direction.

FIG. 10 is a front view showing another example (type B) of a joining device used in the invention.

FIG. 11 is a sectional view showing an example of a combined tape used in the invention.

FIG. 12 is a perspective view showing another more example (type C) of a joining device used in the invention.

FIG. 13 is a front view showing another more example (type C) of a joining device used in the invention.

FIG. 14 is a side view showing another more example (type C) of a joining device used in the invention.

FIG. 15 is a sectional view showing the configuration of the main part of a right-left traverse and support unit of a type-C joining device.

FIG. 16 is a perspective view showing the configuration of one electrode of a heating head of a type-C joining device.

FIG. 17 shows the configuration of one electrode of a heating head of a type-C joining device, where FIG. 17(a) is a front view, FIG. 17(b) is a plan view, and FIG. 17(c) is a sectional front view.

FIG. 18 is a process chart showing the operation of a type-C joining device.

FIG. 19 shows the effect of a type-C joining device.

FIG. 20 is a front view showing another more example (type D) of a joining device used in the invention.

FIG. 21 shows the operation of a type-D joining device.

FIG. 22 shows the main part of a modification of a type-D joining device.

FIG. 23 is a perspective view showing a modification of an electrode used in a type-C joining device.

FIG. 24 is a sectional view showing the main part of a modification of an electrode used in a type-C joining device.

FIG. 25 is a process chart showing an example of the prior art joining method for minute joint metal.

### BEST MODE FOR CARRYING OUT THE INVENTION

The invention is described below with reference to the drawings.

The following description is made for the case that the component to which the invention is applied is a coil C shown in FIG. 4, and that the base metal is composed of a terminal while the minute joint metal is composed of a wire. However, the component, the base metal, and the minute joint metal to which the invention is applied are not limited to these examples.

Described first are embodiments for contacting a minute joint metal, a base metal, and a brazing filler material to each other.

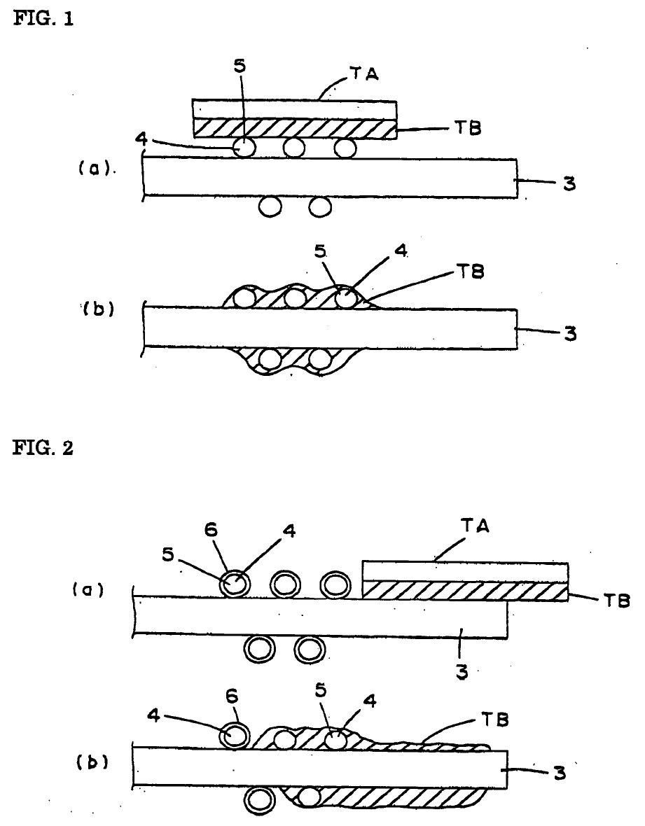

FIG. 1 shows Embodiment 1.

In the configuration of FIG. 1, an end portion 5 of a wire is wound around a terminal 3 in advance. Then, a combined tape composed of an electrically conductive tape TA and a brazing filler material tape TB is overlaid on and pressed against the wire end portion in such a manner that the brazing filler material tape surface contacts to the wire end portion. The electrically conductive tape TA is then heated, whereby the brazing filler material tape is fused. As a result, the fused brazing filler material covers the wire end portion 5 and the terminal 3, whereby the wire end portion 5 is joined to the terminal 3.

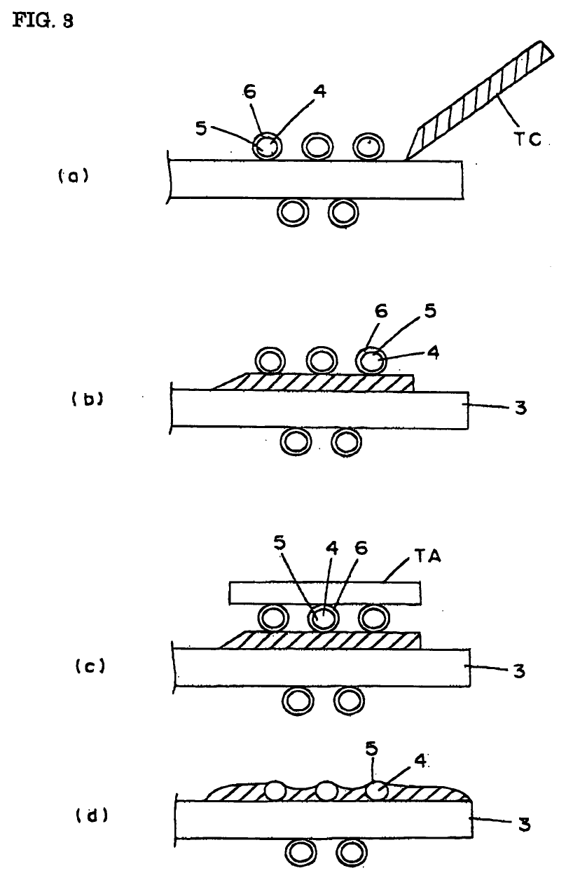

FIG. 2 shows Embodiment 2.

In the configuration of FIG. 2, an end portion of a wire is wound around a terminal 3 in advance. Then, a combined tape composed of an electrically conductive tape TA and a brazing filler material tape TB is overlaid on and pressed against the terminal in the vicinity of the portion where the wire end portion is wound around, in such a manner that the brazing filler material tape surface contacts to the terminal. The electrically conductive tape TA is then heated, whereby the brazing filler material tape is fused. As a result, the fused brazing filler material migrates toward the wire end portion 5 and thereby covers the wire end portion 5 and the terminal 3, whereby the wire end portion 5 is joined to the terminal 3.

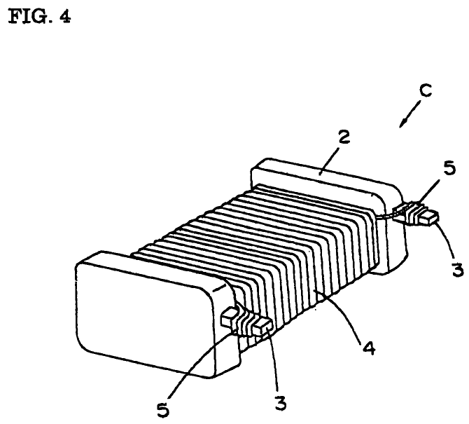

FIG. 3 shows Embodiment 3.

In the configuration of FIG. 3, an end portion 5 of a wire is wound around a terminal 3 in advance. Then, a brazing filler material chip TC is inserted between the wound end portion 5 of the wire and the terminal 3. In this state, an electrically conductive tape TA is pressed against the wire end portion 5. The electrically conductive tape TA is then heated, whereby the brazing filler material chip is fused. As a result, the fused brazing filler material covers the wire end portion 5 and the terminal 5, whereby the wire end portion 5 is joined to the terminal 3.

In the configuration of Embodiment 4, the terminal 3 shown in FIGS. 1-3 is integrated with brazing filler material in advance by means of, for example, plating the terminal with the brazing filler material. Then, an end portion of a wire is wound around the terminal. In this state, an electrically conductive tape TA is pressed against the wire end portion 5 or alternatively the terminal in the vicinity where the wire is wound around. The electrically conductive tape TA is then heated, whereby the brazing filler material having been integrated into the terminal is fused by the heat conducted from the electrically conductive tape TA. As a result, the fused brazing filler material covers the wire end portion 5 and the terminal 3, whereby the wire end portion 5 is joined to the terminal 3.

In Embodiments 1 and 2, the combined tape integrated from an electrically conductive tape and a brazing filler material tape is advanced in the joining operation of each terminal, whereby a renewed portion of the combined tape is used in the joining operation of a new terminal. Here, the electrically conductive tape and the brazing filler material tape need not to be integrated into a combined tape, and may be separate tapes. In this case, both of the electrically conductive tape and the brazing filler material tape are advanced in the joining operation of each terminal, whereby a renewed portion of each tape is used in the joining operation of a new terminal.

In Embodiment 3, in the joining operation of each terminal, a new brazing filler material chip is inserted, and the electrically conductive tape is advanced, whereby a renewed portion is used in the joining operation of the next new terminal.

In Embodiment 4, the electrically conductive tape is advanced in the joining operation of each terminal, whereby a renewed portion is used in the joining operation of the next new terminal.

These embodiments have been described for the case that the end portion 5 of a wire is wound around a terminal 3. However, it is sufficient that the end portion 5 of the wire contacts to the terminal 3. Thus, the end portion 5 of the wire does not need to be wound around the terminal 3.

Further, the method for heating the electrically conductive tape is preferably conducted by circularization. However, the method for heating is not limited to circularization.

Described next is a joining device used in the invention.

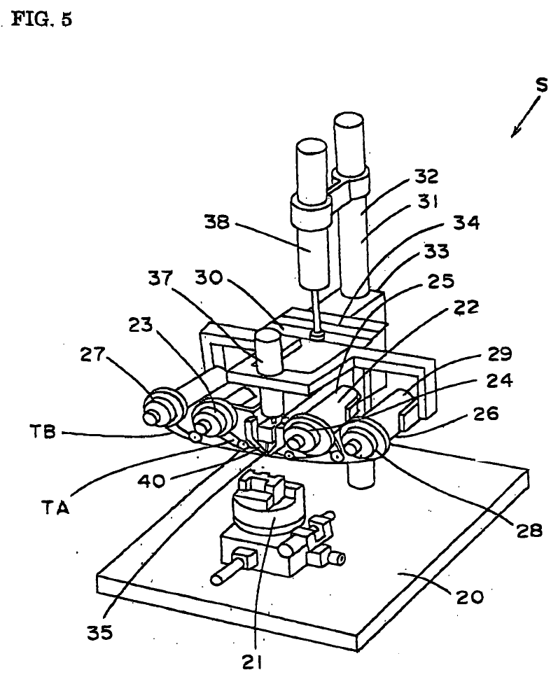

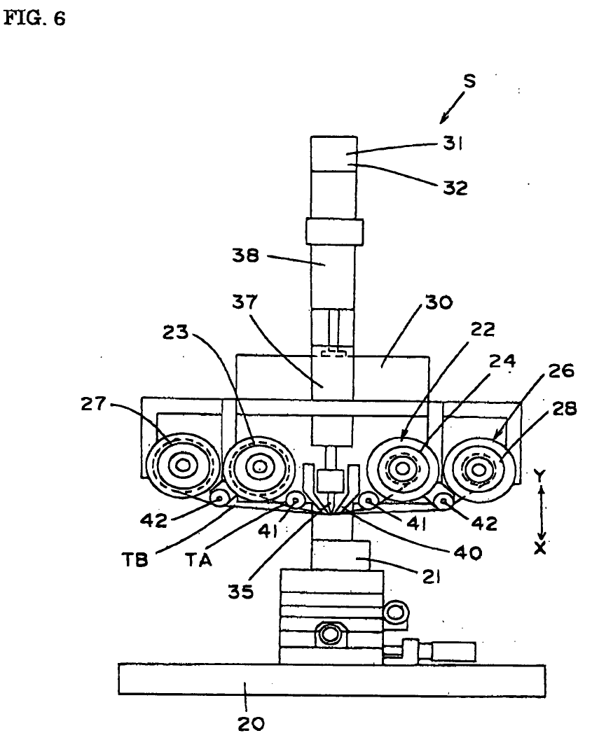

FIGS. 5-7 show an example (referred to as “type A”) of a joining device used in the invention.

In FIGS. 5-7, numeral 20 indicates a machine base. Numeral 21 indicates a support bed. The support bed 21 comprises an X-Y table which is position adjustable.

Numeral 22 indicates a feed unit for an electrically conductive tape used for heating. The feed unit advances the electrically conductive tape so as to renew the pressing portion of the electrically conductive tape in each joining operation.

The electrically conductive tape feed unit 22 comprises; a first reel 23 which is held such as not to revolve freely but capable of revolving in a predetermined angle step; a second reel 24; and a drive unit 25 for driving the revolution of these reels. According to this configuration, an electrically conductive tape is fed and wound in by the two reels. The drive unit 25 can be implemented by a stepping motor, for example.

Numeral 26 indicates a brazing filler material tape feed unit for advancing a brazing filler material tape so as to renew the pressing portion of the tape in each joining operation.

The brazing filler material tape feed unit 26 comprises: a first reel 27 which is held such as not to revolve freely but capable of revolving in a predetermined angle step; a second reel 28; and a drive unit 29 for driving the revolution of these reels. According to this configuration, a brazing filler material tape is fed and wound in by the two reels. The drive unit 29 can be implemented by a stepping motor, for example.

The first reel 23 or 27 and the second reel 24 or 28 are arranged in such a manner that the direction of advance of the brazing filler material tape is the same as that of the electrically conductive tape, and that the brazing filler material tape contacts to the electrically conductive tape.

In the type-A device, the electrically conductive tape feed unit 22 and the brazing filler material tape feed unit 26 are provided separately. Accordingly, the advancing speed and the renewal pitch for the electrically conductive tape can be changed independently of those for the brazing filler material tape. This permits the tapes to be fed appropriately depending on the conditions such as the material and the size of the base metal and the minute joint metal, and thereby improves the universality. Further, although the brazing filler material is consumed, the electrically conductive tape can be re-used, for example, after being filed. The width of the electrically conductive tape may be the same as or different from that of the brazing filler material tape.

Numeral 35 indicates a heating head. The heating head 35 is provided with a contact pressure imparting unit 37. The contact pressure imparting unit 37 comprises an air cylinder, and thereby presses the heating head so as to impart elastically a contact pressure to the electrically conductive tape and the brazing filler material.

Numeral 31 indicates a support member. The support member 31 comprises a pole 32 and a base 33 fixed to the pole 32.

Numeral 30 indicates a base member. The base member 30 is supported on the base 33 via a slider unit 34, in a state movable up and down.

The electrically conductive tape feed unit 22, the brazing filler material tape feed unit 26, the heating head 35, and the contact pressure imparting unit 37 described above are arranged on the base member 30.

Numeral 38 indicates an advance and retract unit. The advance and retract unit 38 comprises an air cylinder supported on the support member 31. The advance and retract unit 38 moves the base member 30 up and down, and thereby moves the electrically conductive tape feed unit 22, the brazing filler material tape feed unit 26, the heating head 35, and the contact pressure imparting unit 37 provided on the base member 30, together.

Numeral 40 indicates a pair of guide members, which are fixed on the base member 30. The guide members 40 permit the electrically conductive tape and the brazing filler material tape to be advanced and renewed without deviating aside.

Numeral 41 indicates a pair of tension rollers which are provided on both sides of the guide members 40 and which impart a tension to the traveling electrically conductive tape by means of springs not shown. Numeral 42 indicates a pair of tension rollers which are provided on both sides of the guide members 40 and which impart a tension to the traveling the brazing filler material tape TB.

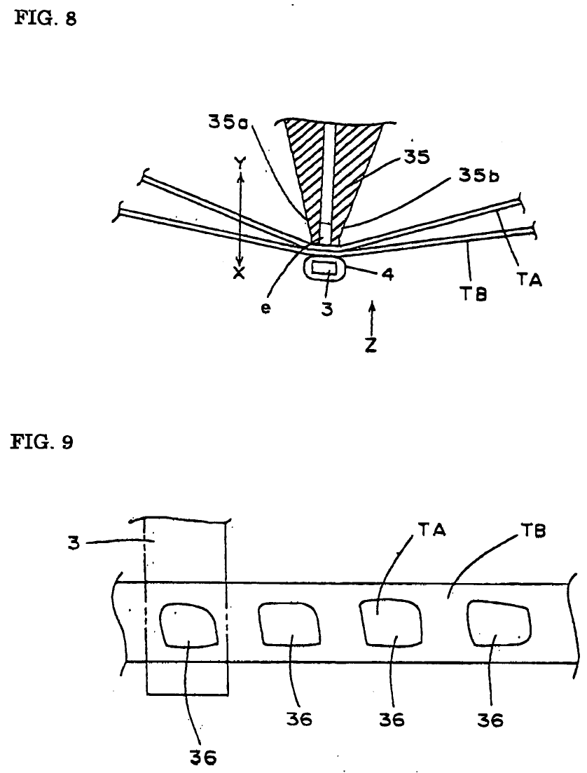

FIG. 8 shows the heating head of the type-A joining device, together with the relation to the heating tape and the brazing filler material tape.

In the method according to the invention, the heated area of the electrically conductive tape heated by the heating head 140 can be limited small, whereby only the center portion of the brazing filler material tape can be melted. For example, the electrically conductive tape may have a narrower width than the brazing filler material tape. Alternatively, the electrodes provided in the heating head may have a smaller area contacting to the electrically conductive tape. As such, when the pressing portion of the brazing filler material tape is renewed in each joining operation, a series of marks 36 of melt out are formed in certain spacing on the brazing filler material tape as shown in FIG. 9.

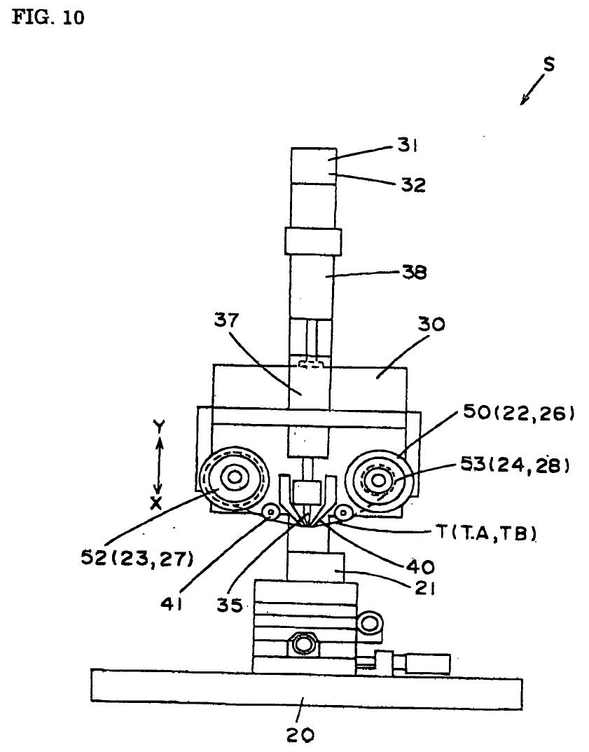

FIG. 10 shows another example (referred to as “type B”) of a joining device used in the invention.

The type-B device is similar to the type-A device. However, the type-B device does not comprise an electrically conductive tape feed unit and a brazing filler material tape feed unit in a separate manner, but comprises a single tape feed unit 50.

Accordingly, in the type-B device, an electrically conductive tape and a brazing filler material tape are used in an overlaid manner, or alternatively a combined tape integrated from an electrically conductive tape and a brazing filler material tape is used. Further alternatively, the tape feed unit feeds solely the electrically conductive tape, while a brazing filler material in the form of a chip or the like is inserted separately.

The tape feed unit 50 comprises a first reel 52 (23, 27) which is held such as not to revolve freely but capable of revolving in a predetermined angle step; a second reel 53 (24, 28); and a drive unit (not shown) for driving the revolution of these reels. The drive unit can be implemented by a stepping motor, for example.

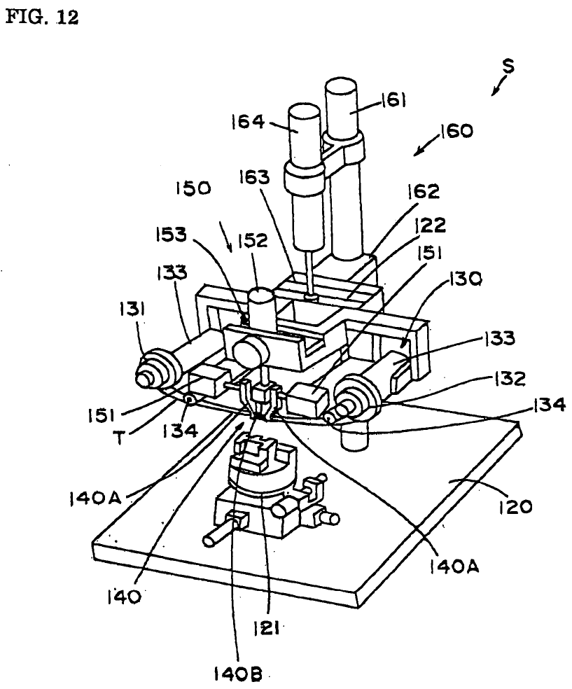

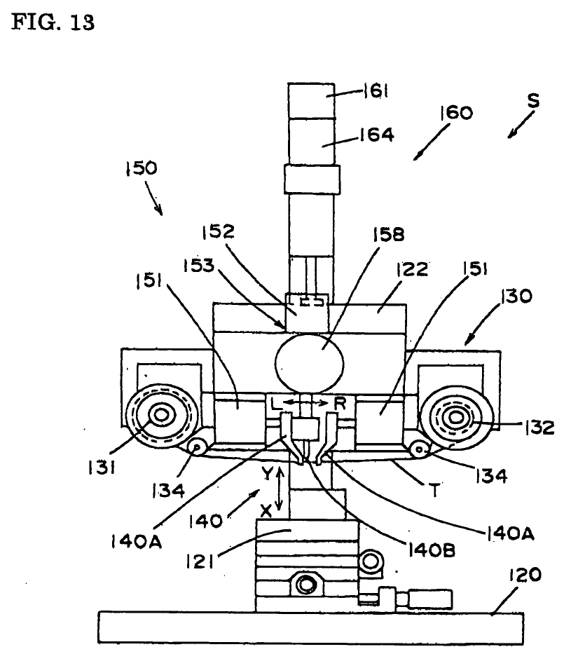

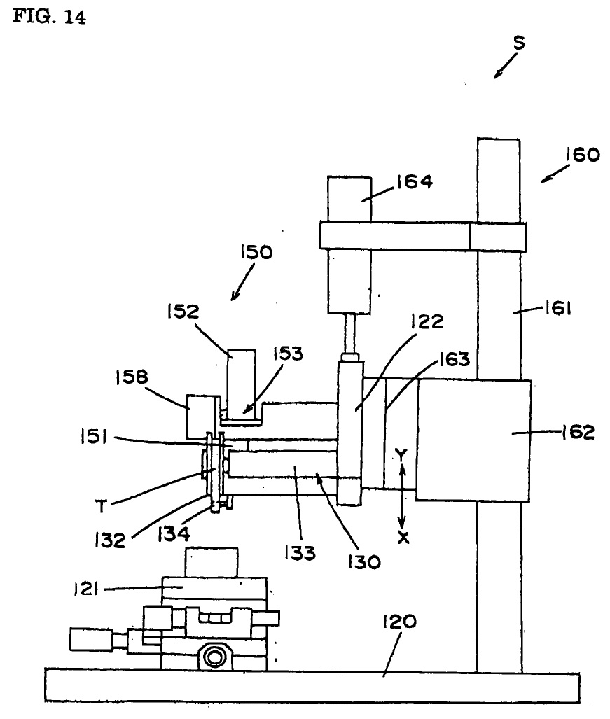

FIGS. 12-17 show another more example (referred to as “type C”) of a joining device used in the invention.

In FIGS. 12-14, numeral 120 indicates a machine base. Numeral 121 indicates a support bed. The support bed 121 comprises an X-Y table which is position adjustable. Numeral 122 indicates a base member. The base member 122 is provided with a tape feed unit, a heating head, and a press unit for pressing the heating head toward the base metal.

Numeral 130 indicates the tape feed unit.

Similarly to the type-B device, the type-C device does not comprise an electrically conductive tape feed unit and a brazing filler material tape feed unit in a separate manner, but comprises the single tape feed unit 130.

Accordingly, also in the type-C device, an electrically conductive tape and a brazing filler material tape are used in an overlaid manner, or alternatively a combined tape integrated from an electrically conductive tape and a brazing filler material tape is used. Further alternatively, the tape feed unit feeds solely the electrically conductive tape, while a brazing filler material in the form of a chip or the like is inserted separately.

The tape feed unit 130 advances the tape and thereby renews the pressing portion of the electrically conductive tape and the brazing filler material in each joining operation. More specifically, the tape feed unit 130 comprises: a first reel 131 which is held such as not to revolve freely but capable of revolving in a predetermined angle step; a second reel 132; and a drive unit 133 for driving the revolution of these reels. The drive unit 133 can be implemented by a stepping motor, for example.

Numeral 134 indicates a pair of tension rollers which impart a tension to the traveling tape by means of springs not shown.

Numeral 140 indicates a heating head for heating the electrically conductive tape. The heating head 140 comprises a positive electrode 140A and a negative electrode 140B which have different pressing directions to each other.

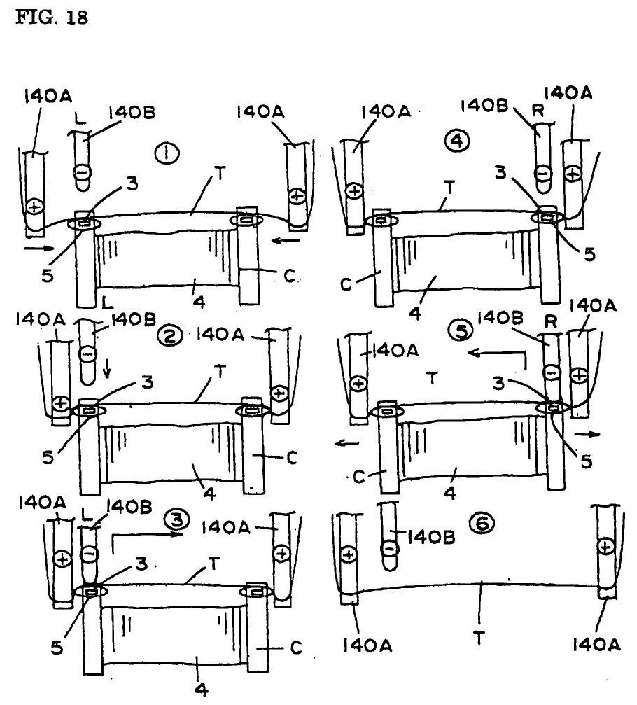

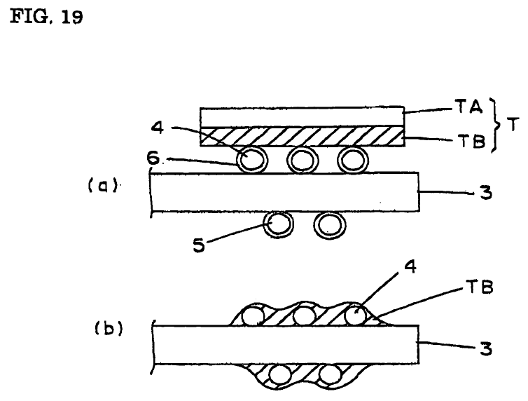

More specifically, one selected from the positive electrode 140A and the negative electrode 140B (the positive electrode 140A is selected in the type-C device) is arranged in the direction perpendicular to the axis of the terminal 3 and on the line formed by the terminals 3, and is located in the right and left outward the terminals 3 in such a manner that the opposing electrodes of the pair can mutually approach and depart, as shown in FIG. 18.

The other one of the positive electrode 140A and the negative electrode 140B (the negative electrode 140B, in the type-C device) is arranged in the direction perpendicular to the axis of the terminal 3 and perpendicular to the line formed by the terminals 3 and is located upward of the direction in such a manner that it can move right and left in two positions that is, in a left position L where the left one of the terminals 3 is pressed and in a right position R where the right one of the terminals 3 is pressed, as shown in FIG. 18.

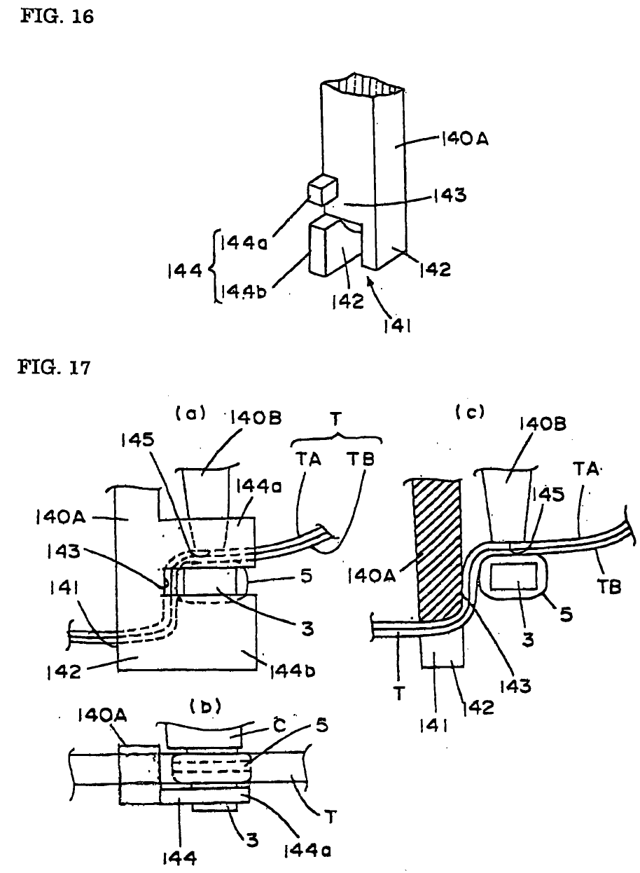

Further, as shown in FIGS. 16 and 17, at least one selected from the positive electrode 140A and the negative electrode 140B (the positive electrode 140A is selected in the type-C device) comprises: a guide section 141 having a pair of guide walls 142 for guiding both edges of the electrically conductive tape TA; a pressing section 143 which is provided successively to the guide section 141 and which presses the electrically conductive tape from the outward in a direction perpendicular to the axis of the terminal 3; and an engaging section 144 for engaging with the terminal 3 and thereby holding the terminal 3. The engaging section 144 comprises a pair of protrusions 144a and 144b which are provided on the pressing section 143 side of the guide wall 142 in a protruding manner and which clamp the terminal 3 in the pressing.

The other one of the positive electrode 140A pair and the negative electrode 140B (the negative electrode 140B, in the type-C device) has the form of a bar provided with a pressing section 145 for pressing the tape from the outward in the other of the directions perpendicular to the axis of the terminal 3.

Numeral 150 indicates pressing unit capable of advancing and retracting the positive electrode 140A and the negative electrode 140B in different directions from each other. The pressing unit 150 comprises: a pair of air cylinders 151 (of a direction) which are driven by air and thereby press one selected from the positive electrode 140A and the negative electrode 140B (the positive electrode 140A is selected in the type-C device) in a direction (right and left); and an air cylinder 152 (of the other direction) which is driven by air and thereby presses the other one of the positive electrode 140A and the negative electrode 140B (the negative electrode 140B, in the type-C device) in the other direction (up and down, which is perpendicular to the above-mentioned direction).

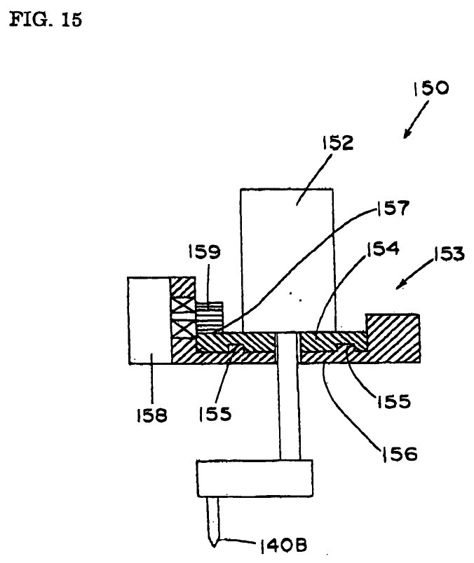

Numeral 153 indicates a right-left traverse and support unit for moving and holding the other electrode, which is the negative electrode 140B, in either the left position L or the right position R described above. As shown in FIG. 15, the right-left traverse and support unit 153 comprises: a slider 154 for supporting the air cylinder 152 (of the other direction); and a support 156 for supporting the slider 154 via rails 155, in a slidable manner. A rack 157 is formed on top of the slider 154. Further, the support 156 is provided with a drive motor 158 capable of revolving forward and backward, while the drive motor 158 is provided with a pinion 159 engaging with the rack 157. When the drive motor 158 revolves forward and backward, the slider 154 is moved via the pinion 159 and the rack 157, whereby this other electrode is moved and held in either the left position L or the right position R.

Numeral 160 indicates a support member for the base member 122. The support member 160 comprises: a pole 161 standing on a machine base 120; and a base 162 fixed on the pole 161. The base member 122 is supported on the base 162 via a well known slider unit 163, in a manner movable up and down.

Numeral 164 indicates an advance and retract unit which comprises an air cylinder supported on the support member 160. The advance and retract unit 164 advances the base member 122 to an advanced position X where joining operation is performed, and retracts the base member to a retracted position Y where joining operation is not performed. The advance and retract unit 164 advances and retracts solely the base member 122, and thereby moves the tape feed unit 130, the heating head 140, and the pressing unit for the heating head, together. This improves the efficiency.

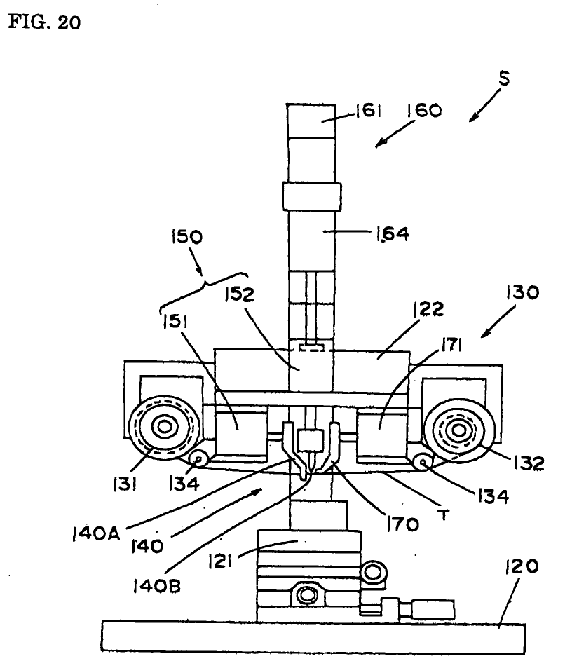

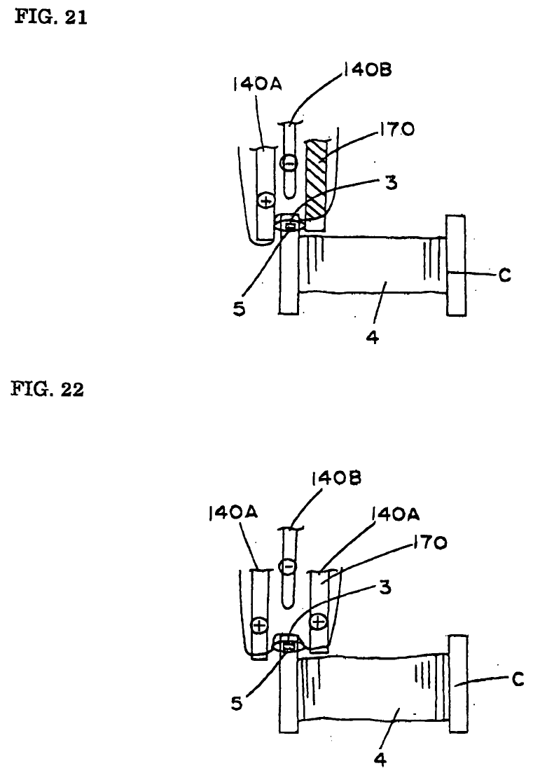

FIGS. 20 and 21 show another more example (referred to as “type D”) of a joining device used in the invention.

The type-D device has a configuration similar to that of the type-C device. However, the type-D device does not comprise the right-left traverse and support unit 153 for electrodes which is provided in the type-C device. Accordingly, the position of the negative electrode 140B is fixed in the right and left direction. Further, a single positive electrode 140A is provided, while a tape T is pressed by an air cylinder 151 (of a direction) of the pressing unit 150.

Further, in place of the right-hand side positive electrodes 140A described above, provided is a pressing member 170 which opposes to the positive electrode 140A and which presses the terminal 3 in the pressing by the opposing positive electrode 140A. The pressing member 170 is formed of an electrically insulating material, and driven by an air-driven cylinder 171 similarly to the positive electrode 140A.

An exemplary procedure of joining operation in the type-D joining device is as follows.

A coil C and terminals are placed on the support bed.

The advance and retract unit 164 lowers the base member 122, and thereby moves the tape feed unit 130, the heating head 140, and the pressing unit for the heating head, to a predetermined position, together.

The air cylinder 151 (of a direction) of the pressing unit 150 is driven, whereby the positive electrode 140A advances and presses the electrically conductive tape T. At the same time, the air cylinder 171 is driven, whereby the pressing member 170 presses the electrically conductive tape T.

Further, the air cylinder 152 (of the other direction) of the pressing unit 150 is driven, whereby the negative electrode 140B advances and presses the electrically conductive tape.

In this state, a voltage is applied between the positive electrode 140A and the negative electrode 140B of the heating head 140. As a result, the electric power generates heat, whereby the heat partially melts the brazing filler material. The melted brazing filler material melts the coating material 6. The brazing filler material spreads out owing to the surface tension, and thereby enters into the space formed by the wire 4 owing to the capillary action. As a result, the end portion 5 of the wire 4 is joined to the terminal 3.

In the type-D device, although not shown in the figure, similarly to the type-C device, when the terminal 3 is pressed by the electrodes 140A and 140B, the engaging section 144 of the positive electrode 140A engages with the terminal 3, while the pressing member 170 holds the terminal 3. This securely prevents the terminal 3 from being distorted and warped, and thereby permits secure welding.

After the welding, the air cylinder 151 (of a direction) of the pressing unit 150 is driven, whereby the positive electrode 140A departs from the terminal 3. At the same time, the air cylinder 152 (of the other direction) of the pressing unit 150 is driven, whereby the negative electrode 140B retracts. Further, the air cylinder 171 is driven, whereby the pressing member 170 having pressed the terminal retracts. As a result, the pressing pressure is released.

In this device, the positive electrode 140A and the negative electrode 140B can retract independently in different directions to each other. This permits easy removal from the electrically conductive tape, and thereby avoids the situation that the electrodes are kept in electric conduction with each other and that further operation becomes impossible. Further, this avoids the necessity of frequent cleaning of the electrodes, and thereby reduces the number of processes and improves the workability.

After that, the joining tape feed unit 130 is driven, whereby the electrically conductive tape and the pressing surface of the brazing filler material are renewed for the processing of the next coil C. These steps are repeated, whereby the welding is performed sequentially.

In this device, the tape T is advanced and renewed by the revolution of the first reel 131 and the second reel 132. This permits easy renewal. Further, when a combined tape integrated from an electrically conductive tape and a brazing filler material is used, the pressing portion of the electrically conductive tape and the brazing filler material tape is renewed at the same time.

These steps are repeated, whereby joining operation is performed easily.

Further, the area heated by the heating head 140 can be limited small, whereby the brazing filler material tape solely in that area is melted. This avoids unnecessary wasting of the brazing filler material. Further, extra brazing filler material is not present in the vicinity of the joined portion of the terminal. This realizes a well finished state and improves the quality of the joined portion. Further, when a brazing filler material having a lower melting point than the minute joint metal is used, the break down of the minute joint metal is avoided in the welding, the strength is not weakened in the terminal, and the strength of the joining is increased. This improves the quality of the welding.

As shown in FIG. 22, the pressing member 170 may be composed of a positive electrode 140A. Various modifications are possible.

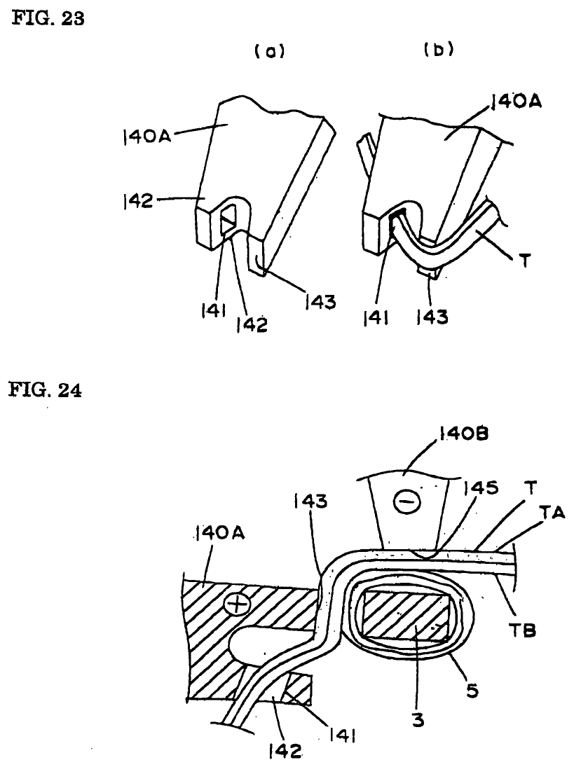

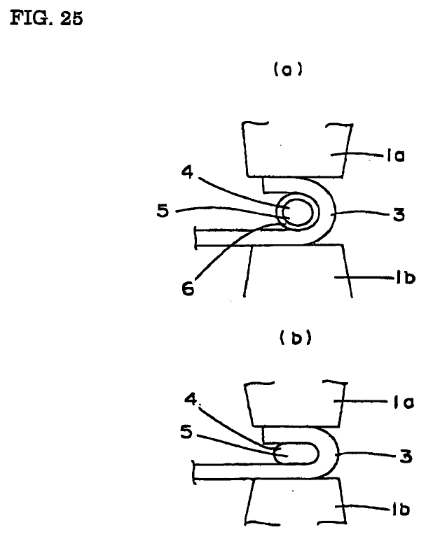

In the above-mentioned embodiments, the shape of the positive electrode 140A is not limited to those described above. Various modifications are possible. FIGS. 23 and 24 show another example of the positive electrode 140A. In this electrode, a guide section 141 is composed of a hole through which the joining tape T passes, while the right and left walls of the hole serve as a pair of guide walls 142 for guiding both edges of the joining tape T. Further, a pressing section 143 for the heating tape TA is provided in the vicinity of the guide section 141.

In the above-mentioned embodiments, the positive electrode 140A may be replaced by a negative electrode, while the negative electrode 140B may be replaced by a positive electrode. Various modifications are possible.

The joining device used in the invention has been described above with some examples. However, the joining device is not limited to these examples.

An example of target to which the invention is applied is an electronic component capable of being contained in a cubic having outer dimensions of 10 mm, such as a coil C as shown in FIG. 4.

In the coil C shown in FIG. 4, a pair of small bar-shaped terminals 3 are provided in the same direction in parallel to each other in the right and left portions of a core body 2 around which a wire 4 is wound. Each end portion 5 of the wire 4 is wound around each terminal 3. The terminals 3 and the end portions 5 of the wire 4 are composed of a metallic material such as copper (Cu), and can be joined using brazing filler material.

The wire 4 is coated or not coated with coating material 6. In case that the wire 4 is coated with coating material 6, the wire 4 can roughly be classified according to the heat resistance index of the coating material 6 into: those having the index lower than 150 such as polyurethane coated wires; those having the index of 150 or higher and 170 or lower such as polyester coated wires; and those having the index higher than 170 such as polyamide-imide coated wires.

In the invention, the brazing filler material is a known brazing filler material. The material may be: a soft solder, such as tin, lead, zinc, and ordinary solder; or a hard solder, such as copper, gold, and silver. The brazing filler material is appropriately selected from those having a melting temperature lower than that of the minute joint material and the base material to be joined.

Examples of the composition of copper-based brazing filler material include: an alloy composed of Cu containing Ni (5.7 wt %). Sn (9.3 wt %), and P (6.5 wt %); and an alloy composed of Cu containing Sn (20 wt %). Further, the brazing filler material may be an amorphous which has a similar composition and which has been temporarily melted and then cooled rapidly. Such an amorphous has neither an oxide film in the surface nor segregation in the components, and is applicable to a brazing filler material composed of a brittle composition which can be neither rolled into a tape nor formed into a wire.

Such a brazing filler material is used in the form of a tape or a chip.

The brazing filler material tape TB used in the invention has a thickness of about 0.01-0.05 mm and a width of about 0.5-5 mm. The brazing filler material chip used in the invention has a thickness of about 0.01-0.05 mm and a width and a length of about 0.5-5 mm.

The material of the electrically conductive tape may be any one which can be energized by electric power and which does not melt at the temperature where the brazing filler material melts.

For example, it may be a material such as molybdenum (Mo) and tungsten (W) which has a rather high electric resistance and hence generates a rather large Joule heat during energization. However, good conductive material may also be used. Even such an electrically conductive material can generate heat if the pressing pressure against the electrodes is controlled during energization.

Further, an electrically insulating material tape which is composed of an inorganic material or the like and the surface of which is treated into an electrically conductive state may be used as the electrically conductive tape.

The electrically conductive tape TA used in the invention has a thickness of about 0.01-0.05 mm and a width of about 0.5-5 mm.

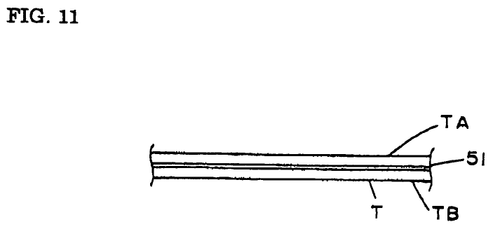

The combined tape according to the invention indicates a tape integrated from an electrically conductive tape TA and a brazing filler material tape TB. For example, the combined tape may be integrated by adhering an electrically conductive tape TA and a brazing filler material tape TB with adhesive 51 as shown in FIG. 11. Alternatively, the combined tape T may be integrated by the spot welding of an electrically conductive tape TA and a brazing filler material tape TB. Further, an electrically conductive tape TA may be coated with a brazing filler material by means of blast coating, vapor deposition coating, plating, printing, or the like, whereby the electrically conductive tape TA and the brazing filler material tape TB may be integrated. Any method for the integration can be used.

In Embodiment 4 the method for integrating the terminal and the brazing filler material is the same as that for the combined tape.

Any of the above-mentioned type-A, type-B, type-C, and type-D joining devices can be used in any of the above-mentioned Embodiments 1, 2, 3, and 4 for contacting a minute joint metal, a base metal, and a brazing filler material to each other. For example, when the type-A joining device is used in Embodiment 3, the brazing filler material tape feed unit is excessive and useless. However, the joining device is still adoptable.

As such, various combinations are possible. Typical combinations among these are used in the following description of the procedure of joining operation.

[Joining Operation Using Type-A Joining Device]

In Embodiment 1 for contacting a minute joint metal, a base metal, and a brazing filler material to each other, as shown in FIG. 1(a), an end portion 5 of a wire 4 is added and wound around a terminal 3 in advance. Then, the terminal 3 around which the end portion 5 of the wire 4 is wound is placed on the support bed 21 together with the coil C.

In this embodiment, the wire end portion 5 is not coated with insulating material.

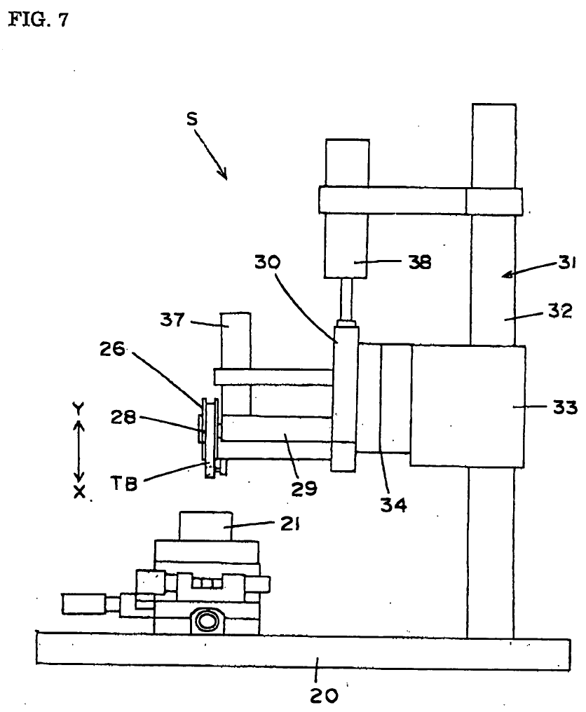

Then, as shown in FIGS. 7, 1(a), the air cylinder of the advance and retract unit 38 is driven, whereby the base member 30 is moved to the advanced position X where the electrically conductive tape TA and the brazing filler material tape TB can be pressed against the terminal 3 placed on the support bed 21. Then, the heating head presses the brazing filler material tape TB and the electrically conductive tape TA against the wire and the terminal.

In this state, a voltage is applied between the positive electrode and the negative electrode provided in the heating head 35. As a result, the electrically conductive tape is energized and thereby generates a Joule heat, whereby the heat partially melts the brazing filler material tape TB. After that, as shown in FIGS. 5-7, the air cylinder of the advance and retract unit 38 is driven, whereby the base member 30 is moved to the retracted position Y where the heating tape TA and the brazing filler material tape TB depart from the advanced position X.

As a result of this joining operation, as shown in FIG. 1(b), the end portion 5 of the wire 4 is joined to the terminal 3 with the fused brazing filler material. The brazing filler material spreads out owing to the surface tension, and thereby enters into the space formed by the wire 4 owing to the capillary action.

After that, the heating tape feed unit 22 and the brazing filler material tape feed unit 26 are driven, whereby the pressing portion of the heating tape TA and the fused portion of the brazing filler material tape TB are renewed for the processing of the next coil C. These steps are repeated, whereby the welding is performed sequentially.

In this case, the heating tape TA and the brazing filler material tape TB are renewed by the revolution of the first reel 23 or 27 and the second reel 24 or 28. This permits easy renewal, Further, the brazing filler material is adhered to the joined portion only by that the pressing portion of the electrically conductive tape TA and the fused portion of the brazing filler material tape TB are renewed and pressed in each joining operation. This permits easy joining operation. Further, the area heated by the heating head 35 can be limited small, whereby the brazing filler material of solely the amount necessary for joining can be melted and adhered. This avoids unnecessary wasting of the brazing filler material. Further, extra brazing filler material is not present in the vicinity of the joined portion. This realizes a well finished state. Further, since the wire does not melt at the melting temperature of the brazing filler material, the break down of the wire is avoided in the welding, while the strength is not weakened in the terminal, and the strength of the joining is increased. This improves the quality of the welding.

In Embodiment 2 for contacting a minute joint metal, a base metal, and a brazing filler material to each other, a difference from Embodiment 1 is that the heating head 35 presses the brazing filler material tape TB and the heating tape TA against the terminal 3 in the vicinity (the tip of the terminal 3, in the figure) of the wire 4. Another difference is that as shown in FIG. 2(b), the fused brazing filler material flows and melts the insulating material 6 which is coated with the brazing filler material, whereby the wire 4 is exposed, and whereby the end portion 5 of the exposed wire 4 is joined to the terminal 3 with the brazing filler material. The other points are similar to Embodiment 1.

[Joining Operation Using Type-B Joining Device]

In Embodiment 1 for contacting a minute joint metal, a base metal, and a brazing filler material to each other, as shown in FIG. 1(a), an end portion 5 of a wire 4 is added and wound around a terminal 3 in advance. Then, the terminal 3 around which the end portion 5 of the wire 4 is wound is placed on the support bed 21 as a single unit of a coil C.

In this embodiment, the wire end portion 5 is not coated with insulating material.

The air cylinder of the advance and retract unit 38 is driven, whereby the base member 30 is moved to the advanced position X where the combined tape T can be pressed against the terminal 3 placed on the support bed 21.

Then, the heating head presses the combined tape T against the wire and the terminal.

In this state, a voltage is applied between the positive electrode and the negative electrode provided in the heating head 35. As a result, the electrically conductive tape is energized and thereby generates a Joule heat, whereby the heat partially melts the brazing filler material of the combined tape.

After that, the air cylinder of the advance and retract unit 38 is driven, whereby the joining tape T is moved to the retracted position Y where the tape departs from the advanced position X. Then, the tape feed unit 50 is driven, whereby the pressing portion of the joining tape T is renewed. These steps are repeated, whereby the welding is performed sequentially.

In this case, the joining tape T is integrated from an electrically conductive tape TA and a brazing filler material tape TB. This permits easy handling, and simplifies the device.

In Embodiment 2 for contacting a minute joint metal, a base metal, and a brazing filler material to each other, a difference from Embodiment 1 is that the heating head 35 presses the combined tape T against the terminal 3 in the vicinity (the tip of the terminal 3, in the figure) of the wire 4. Another difference is that as shown in FIG. 2(b), the fused brazing filler material flows and melts the insulating material 6 which is coated with the brazing filler material, whereby the wire 4 is exposed, and whereby the end portion of the exposed wire 4 is joined to the terminal 3 with the brazing filler material. The other points are similar to Embodiment 1.

In the joining operation in the type-B joining device, in place of the combined tape, an electrically conductive tape TA and a brazing filler material tape TB may be used in a manner not adhered but simply overlaid. Alternatively, the electrically conductive tape TA may solely be used, whereby a brazing filler material having the shape of a chip may be inserted between the wire and the terminal as in Embodiment 3.

### EXPERIMENTAL EXAMPLE

Comparison was carried out between the welding by means of the type-C joining device according to the invention and the prior art micro resistance welding (fusing resistance welding).

The base material used was a copper terminal having a thickness of 0.13 mm, a width of 0.26 mm, and a length of 0.86 mm.

The minute joint metal used was a so-called magnet wire which was a polyimide-coated copper wire having a diameter of 0.05 mm (AIW type E (220 degrees)).

The brazing filler material in the brazing filler material tape used was a Cu-based amorphous alloy having a composition of Cu (Bal), Ni (5.7), Sn (9.3), and P (6.5) in percentage by weight (wt %). The maximum temperature of solid phase of this material was 595 degrees, while the minimum temperature of liquid phase was 650 degrees. The optimum brazing temperature was 685 degrees.

Each of welding samples (10 samples each) were tested by the method that the terminal and the wire were pulled apart in the opposite directions using a digital force gauge, and that the tensile strength was measured at the time of break down. This value was used as the welding strength. For a reference use, the tensile strength of the wire alone was also measured. Table 1 shows the result.

As seen from Table 1, the welding strength of the welding samples according to the invention has an excellent value in comparison with that of the welding samples according to the prior art fusing resistance welding. This value is close to the break strength of the wire itself.

TABLE 1

| | Break strength of | Break strength of | Break |
|---|---|---|---|
| | welding sample | welding sample | strength of |
| | according to the | according to fusing | wire itself |
| | invention (gf) | resistance welding (gf) | (gf) |
| Sample 1 | 27.2 | 18.1 | 30.8 |
| Sample 2 | 30.1 | 19.5 | 32.3 |
| Sample 3 | 29.7 | 17.8 | 32.5 |
| Sample 4 | 27.4 | 16.6 | 31.5 |
| Sample 5 | 27.5 | 16.8 | 31.8 |
| Sample 6 | 28.6 | 17.2 | 32.1 |
| Sample 7 | 28.1 | 16.4 | 32.2 |
| Sample 8 | 27.9 | 18.1 | 32.8 |
| Sample 9 | 29.3 | 16.1 | 32.1 |
| Sample 10 | 30.2 | 15.4 | 32.9 |
| Average | 28.6 | 17.2 | 32.1 |

### INDUSTRIAL APPLICABILITY

According to the invention, a brazing filler material having a lower melting temperature than a minute joint metal is fused by heat conducted from an electrically conductive tape which is heated, whereby the minute joint metal is welded to a base material. Accordingly, the minute joint metal does not melt at the melting temperature of the brazing filler material. This avoids the break down of the minute joint metal during the welding. Further, this avoids excessive load to the base material and the minute joint metal, hence does not weaken the strength of the base material and the minute joint metal, and realizes strong joining.

Accordingly, the method according to the invention has a high utility value, for example, in the field of lead-wire extraction from a small electronic component.

1. A method for joining a minute joint metal to a base metal, comprising the steps of: contacting a minute joint metal, a base metal, and a brazing filler material to each other; pressing an electrically conductive tape toward these materials by means of a heating head; heating the electrically conductive tape; fusing the brazing filler material by means of the heat conducted from the electrically conductive tape which is heated; and joining the minute joint metal to the base metal with said fused brazing filler material.

2. A method for joining a minute joint metal to a base metal according to claim 1, wherein said brazing filler material is composed of: an alloy the main component of which is the metal of said base metal or said minute joint metal: or an amorphous metal fabricated by temporarily fusing said composition and then solidifying it rapidly.

3. A method for joining a minute joint metal to a base metal according to claim 1, wherein said heating is conducted by circularization using a positive electrode and a negative electrode.

4. A method for joining a minute joint metal to a base metal according to claim 3, wherein the positive electrode and the negative electrode are driven independently.

5. An apparatus for joining a minute joint metal to a base metal, comprising: a tape feed unit; a heating head for heating an electrically conductive tape; a press unit for pressing said heating head toward the base metal: a traverse unit for causing the entirety of said units to travel as a single unit; and a base metal support bed.

6. An apparatus for joining a minute joint metal to a base metal according to claim 5, wherein: the tape feed unit comprises both a feed unit for an electrically conductive tape and a feed unit for a brazing filler material tape.

7. An apparatus for joining a minute joint metal to a base metal according to claim 5 or claim 6, wherein the heating head is provided with a positive electrode and a negative electrode.

8. An apparatus for joining a minute joint metal to a base metal according to claim 5 or claim 6, wherein: said heating head is provided with a positive electrode and a negative electrode; and the positive electrode and the negative electrode can be driven independently.

9. A combined joining tape for joining a minute joint metal to a base metal, wherein an electrically conductive tape and a brazing filler material tape are integrated into a single tape.

10. A combined joining tape for joining a minute joint metal to a base metal according to claim 9, wherein said brazing filler material is composed of: an alloy the main component of which is the metal of said base metal or said minute joint metal; or an amorphous metal fabricated by temporarily fusing said composition and then solidifying it rapidly.
